(19) United States
(12) Patent Application Publication
(10) Pub. No.: US 2024/0184524 A1
(43) Pub. Date: Jun. 6, 2024

(54) CURRENT MODE HARDWARE CORES FOR MACHINE LEARNING (ML) APPLICATIONS

(71) Applicant: International Business Machines Corporation, Armonk, NY (US)

(72) Inventors: Sudipto Chakraborty, Plano, TX (US); Rajiv Joshi, Yorktown Heights, NY (US)

(21) Appl. No.: 18/075,366

(22) Filed: Dec. 5, 2022

(51) Int. Cl. G06F 7/523; G06F 7/50

(52) U.S. Cl. CPC G06F 7/523; G06F 7/50

(57) ABSTRACT

An apparatus includes a current-mode multiply-accumulate (MAC) core with a plurality of parallel current carrying paths. Each path is configured to carry a unit current based on a state of an input variable, a weight, and a configuration vector. The plurality of current carrying paths are arranged in groups, and each group has a summation line. Also included are a plurality of current mode interfaces. Each current mode interface of the plurality of current mode interfaces is coupled to a corresponding summation line of the plurality of summation lines. A plurality of current mode comparators are coupled to the plurality of current mode interfaces and configured to compare current on the corresponding one of the plurality of summation lines to a plurality of corresponding reference currents.

### BACKGROUND

The present invention relates to the electrical, electronic, and computer arts, and more specifically, to electronic circuitry suitable for artificial intelligence (AI) applications and the like.

AI is widely used for many applications, such as object recognition, voice recognition, image classification, security applications, and the like. Another possible application is the field of wake-up receivers; i.e., a receiver that operates in a very low power mode and wakes up just in time for the data to be received. It is desirable that modern AI systems be capable of efficient local decision-making, require only infrequent communications to the cloud, and be capable of secure calculations. Further, these goals should be achievable at low power, high throughput, and with processing in real time.

So-called “tiny” machine learning refers to machine learning technologies and applications including hardware, algorithms, and software capable of performing on-device sensor data analytics at extremely low power, typically in the mW range and below. Such “tiny” ML advantageously enables a variety of always-on use-cases and targets battery operated devices.

Accordingly, it will be appreciated that so-called “tiny” ML applications require ultra-low power hardware cores for AI applications. Indeed, many current and projected future AI and machine learning applications require ultra-low latency multiply and accumulate (MAC), and decision-making blocks. Most of the prior implementations of machine learning engines use cascades of multiply-and-accumulate, integrator, comparator, and decision making digital blocks (including comparators and latches). These implementations are typically digital in nature and are realized using switched capacitor type structures. Capacitor-based structures suffer from inherent nonlinearity, charging and discharging over full supply rails, and finite mismatch performance. They also consume a larger area as compared to transistors in nanometer complementary metal oxide semiconductor (CMOS) nodes.

Classical analog circuits include a variety of continuous time analog circuits (such as variable gain amplifiers and mixers), but they do not provide a digital equivalent output. Analog circuits provide inherent advantages in low power signal processing due to information combination (after the analog waveform is obtained at the output of the digital to analog converter (DAC)). As the analog signal processing elements use minimal switching activities, they lead to ultra-low power consumption. A particular advantage of analog signal processing lies in the construction of current mode circuits, where the outputs of various blocks can be connected to perform a variety of addition and subtraction operations. Current mode designs lead to the realization of such operations without additional distortion, making them an excellent choice for low power designs.

### SUMMARY

Principles of the invention provide techniques for current mode hardware cores for machine learning (ML) applications. In one aspect, an exemplary apparatus includes a current-mode multiply-accumulate (MAC) core comprising a plurality of parallel current carrying paths, each path configured to carry a unit current based on a state of an input variable, a weight, and a configuration vector, the plurality of current carrying paths being arranged in groups, each group having a summation line; a plurality of current mode interfaces, each current mode interface of the plurality of current mode interfaces being coupled to a corresponding summation line of the plurality of summation lines; and a plurality of current mode comparators coupled to the plurality of current mode interfaces and configured to compare current on the corresponding one of the plurality of summation lines to a plurality of corresponding reference currents.

In another aspect, another exemplary apparatus includes a first current mode multiply-accumulate core configured to multiply each of a plurality of elements of a first input vector with first corresponding weights and to sum resulting products of the multiplication; and a second current mode multiply-accumulate core configured to multiply each of a plurality of elements of a second input vector with second corresponding weights and to sum resulting products of the multiplication, the second current mode multiply-accumulate core being coupled to a first current mode multiply-accumulate core.

In still another aspect, still another exemplary apparatus includes a plurality of current mode multiply cells arranged in rows and columns; a plurality of input mixers, each input mixer having an output coupled to an input of a corresponding row of current mode multiply cells, each input mixer having a signal input and a phase component input; and a plurality of output mixers, each output mixer having a signal input coupled to an output of a corresponding row of current mode multiply cells and having a phase component input and an output.

In a further aspect, a further exemplary apparatus includes a first field effect transistor having a first source-drain terminal coupled to a first voltage rail, a gate, and a second source-drain terminal; a second field effect transistor having a first source-drain terminal coupled to the second source-drain terminal of the first field effect transistor, a gate, and a second source-drain terminal; and a third field effect transistor having a first source-drain terminal coupled to the second source-drain terminal of the second field effect transistor, a gate, and a second source-drain terminal. The further exemplary apparatus also includes a fourth field effect transistor having a first source-drain terminal coupled to the second source-drain terminal of the third field effect transistor, a gate, and a second source-drain terminal coupled to a second voltage rail; a fifth field effect transistor having a first source-drain terminal coupled to the second source-drain terminal of the first field effect transistor and the first source-drain terminal of the second field effect transistor, a gate, and a second source-drain terminal; and a sixth field effect transistor having a first source-drain terminal coupled to the second source-drain terminal of the fifth field effect transistor, a gate, and a second source-drain terminal coupled to the second source-drain terminal of the third field effect transistor and the first source-drain terminal of the fourth field effect transistor. The further exemplary apparatus additionally includes a first current mode multiply-accumulate core configured to multiply each of a plurality of elements of a first input vector with first corresponding weights and to sum resulting products of the multiplication, the first current mode multiply-accumulate core being coupled to the first source-drain terminal of the third field effect transistor and the second source-drain terminal of the second field effect transistor; and a second current mode multiply-accumulate core configured to multiply each of a plurality of elements of a second input vector with second corresponding weights and to sum resulting products of the multiplication, the second current mode multiply-accumulate core being coupled to the first source-drain terminal of the sixth field effect transistor and the second source-drain terminal of the fifth field effect transistor.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, an action carried out by semiconductor fabrication equipment, or the like, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in hardware such as digital and analog circuitry as described herein. This circuitry can then be used in a device, such as an Internet-of-Things (IOT) device, to carry out inferencing. Some aspects, such as training to determine weights and/or computer-aided semiconductor design and manufacturing can be implemented with the aid of a computer program product including a computer readable storage medium with computer usable program code for performing appropriate techniques. The code can then be executed on a system (or apparatus) including a memory, and at least one processor that is coupled to the memory and operative to perform the techniques.

Techniques of the present invention can provide substantial beneficial technical effects. Some embodiments may not have these potential advantages and these potential advantages are not necessarily required of all embodiments. For example, one or more embodiments provide low power circuitry, appropriate for tiny ML applications, wake-up radios, security applications, and the like. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows prior art aspects of neural networks;

FIG. 2A shows aspects of training and/or inference processes employed with aspects of the invention;

FIG. 2B shows an embodiment of a multiply-accumulate (MAC) core, current mode interface, and current-mode comparator, according to an aspect of the invention;

FIG. 3 shows another embodiment of a multiply-accumulate (MAC) core, a reference current, and a current-mode comparator, according to an aspect of the invention;

FIG. 4 shows at least a portion of a multiply-accumulate (MAC) core, and its associated external connections, according to an aspect of the invention;

FIG. 5A shows an embodiment of a bidirectional current mode input/output (I/O) structure, according to an aspect of the invention;

FIG. 5B shows another embodiment of a bidirectional current mode input/output (I/O) structure, according to an aspect of the invention;

FIG. 6 shows use of a multiply-accumulate (MAC) core, in accordance with an aspect of the invention, as part of a multiple-input multiple-output (MIMO) (e.g., RADAR) array;

FIG. 7 shows the use of two MAC cores, according to aspects of the invention, employed to implement a linear algebraic equation (including addition and/or subtraction);

FIG. 8 shows implementing hierarchical higher order multiplication with two MAC cores, according to aspects of the invention;

FIG. 9 shows two MAC cores, according to aspects of the invention, connected to a comparator;

FIG. 10 depicts a computing environment useful in connection with some aspects of the present invention (e.g., representative of a general-purpose computer that could implement a design process such as that shown in FIG. 11; could also represent aspects of an IoT device that could use aspects of the invention as a co-processor); and

FIG. 11 is a flow diagram of a design process used in semiconductor design, manufacture, and/or test.

### DETAILED DESCRIPTION

As noted, most of the prior implementations of machine learning engines use cascades of multiply-and-accumulate, integrator, comparator, and decision making digital blocks (including comparators and latches). These implementations are typically digital in nature and are realized using switched capacitor type structures. Capacitor-based structures suffer from inherent signal dependent nonlinearity, charging and discharging over full supply rails, and finite mismatch performance. Classical analog circuits include a variety of continuous time analog circuits (such as variable gain amplifiers and mixers), but they do not provide a digital equivalent output. One or more embodiments advantageously provide a hybrid multiplier, with input and outputs in the digital domain, and with the core in analog domain. In one or more embodiments, this core is reconfigurable with respect to linear operations such as multiplication, accumulation, and subtraction.

One or more embodiments advantageously provide a low latency current mode engine suitable for ML applications, including “tiny” ML applications. In one or more embodiments, an exemplary system, with a current mode multiply and accumulate core, provides digitally configurable current density, digitally configurable resolution for the MAC array, a direct interface from MAC to current mode comparator, and/or bidirectional current mode computation. Furthermore, at least some embodiments can provide one or more of programmable current density, subthreshold operation for low voltage and low power, a reconfigurable multiplier fully reconfigurable for arbitrary function(s), and/or a seamless interface with MRAM for current mode storage and computation.

In one or more embodiments, exemplary method steps include designing current mode cores for ML applications, such as tiny ML applications; designing current mode comparators for faster latency; providing mid-rail input and output common mode voltages; reconfigurable current density for the multiplier cores; seamless bidirectional operation using a folded cascode structure; fully current mode architecture and interface with comparator; and/or low power, appropriate for tiny ML applications, wake-up radios, security applications, and the like.

One or more embodiments are suitable for many different applications in AI, including tiny ML, advantageously providing reconfigurability using a low latency, current mode architecture. One or more embodiments are suitable, for example, for use in analog circuits employed in the Internet-of-Things (IOT), neuromorphic computing, analog deep neural networks (DNN), a magnetic random-access memory (MRAM)-based memory interface, and the like. One or more embodiments can be implemented, for example, using nanosheet field-effect transistor (FET) technology.

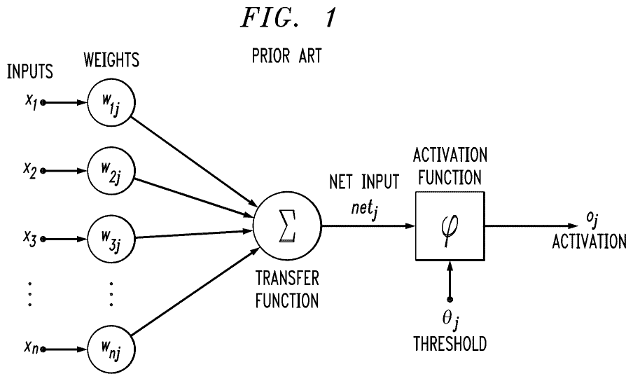

Referring to FIG. 1, one key element in deep learning is the perceptron, where input from many sources is accumulated and a response is triggered when a threshold θⱼ is reached. A neural network is an interconnected system of perceptrons. A deep neural network (DNN) is one type of deep learning network. A string of layers (multilayer perceptron) are connected with initial weights at random values. The DNN is formed of several layers (e.g., an input layer, several hidden layers, and an output layer. Weights w_{i,j} are determined during training, in which known data is presented and processed. For example, in supervised training, both the inputs and the outputs are provided. The network then processes the inputs (during forward propagation) and compares its resulting outputs against the desired outputs. Errors are then propagated back through the system (backpropagation), causing the system to adjust the weights which control the network. Many repeated cycles are needed to complete training (which is very computationally intensive).

Once the network is trained, it can be used for inference (classification), during which only forward propagation is required. The products of the weights and the inputs xᵢ can be summed at each neuron in each layer. The skilled artisan will be familiar with the concepts, processes, and variable names in FIG. 1.

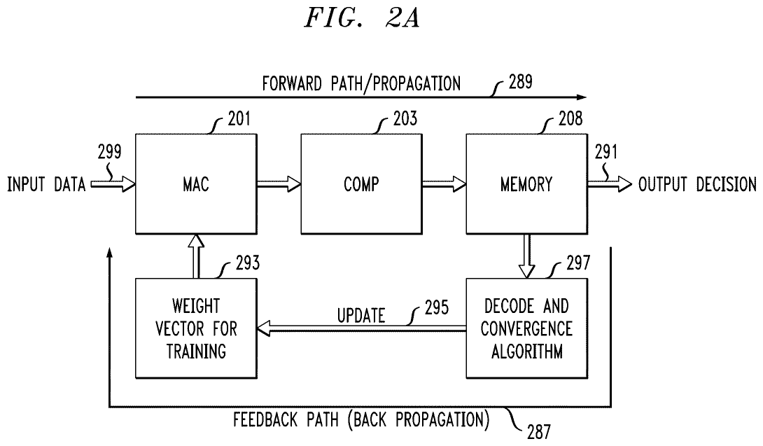

FIG. 2A shows an illustration of the operation of an AI algorithm using an analog multiply accumulate (MAC) block 201 for low power machine learning (ML) applications. First, the AI engine is trained using known data. Input data 299 is represented using digital bits. The engine includes the energy efficient MAC 201, followed by a comparator 203 to obtain decision logic, which is stored in the memory 208. A digital algorithm 297 determines a suitable convergence criterion (e.g., error less than a than a desired value). The skilled artisan is familiar with selecting convergence criteria for machine learning, and given the teachings herein, can do so heuristically for given domains. After achieving the convergence criterion, the weight vectors are updated as seen at 295, and the final weights corresponding to the training element, seen at 293, are stored in memory 208.

In the very beginning, the training starts with an initial weight (initial setting). A known basis function (corresponding to known data such as a known image or the like) is applied, and the weights are updated until the convergence criterion is achieved (i.e., training complete). The weight vector is stored in the memory 208. This process is continued until a total of N-item based training is complete (N represents the number of basis functions). After the weight vectors are obtained in the memory 208, the AI engine takes input (e.g., an unknown image) 299 and computes the MAC outputs corresponding to the N known weight vectors. The outputs are compared with the known outputs to achieve the closest match to a known output or a linear combination of the known outputs. The result is then output at 291. The skilled artisan will be generally familiar with forward propagation 289 and back propagation 287 in the training of a neural network.

Referring now to FIG. 2B, one or more embodiments include an N-bit MAC portion 201 (with adjustable current density), directly interfacing with a current-mode comparator 203. Portion 201 provides a (fully) current mode multiply and accumulate core, which in turn provides digitally configurable current density and digitally configurable resolution for the MAC array. As noted, at least some embodiments can provide one or more of programmable current density, subthreshold operation for low voltage and low power, a reconfigurable multiplier fully reconfigurable for arbitrary function(s), and/or a seamless interface with a memory/storage element such as memory cells 208, for current mode storage and computation. Magnetic random access memory (MRAM) is a non-limiting example of a suitable memory technology. MRAM is a memory that works using current mode signals for read and write operations. By using MRAM, the variables that are processed using current mode operations can be directly stored into MRAM.

The two inputs of the current mode comparator 203 are shown at region 205 and represent the direct interface from the MAC portion 201 to the current mode comparator 203. The top rail 202 in MAC array 201 is a summation line.

One or more embodiments advantageously provide pertinent attributes for next generation ultra-low-power (ULP) AI applications, including low power, low area (on the chip), modularity, scalability, ability to process vector multiplication operations, direct interface to low latency memory elements (e.g. MRAM), and/or in memory computation (non-Von Neumann architecture). While digital scaling is helpful, one or more embodiments provide an innovative architecture/circuit/interface with the potential, for example, of 10-30× improvement as compared to the prior art. One or more embodiments employ a current mode approach for low latency; provide a current mode MAC implementation using sub-V_{T} (V_{T}=threshold voltage) CMOS technology; provide easy process and temperature (P, T) compensation for latency and functionality; provide a current mode interface between a MAC core 201 and a dynamic comparator 203; provide a power consumption significantly less than 50 μW; and/or provide the potential for implementation in, for example, the 3 nm technology node.

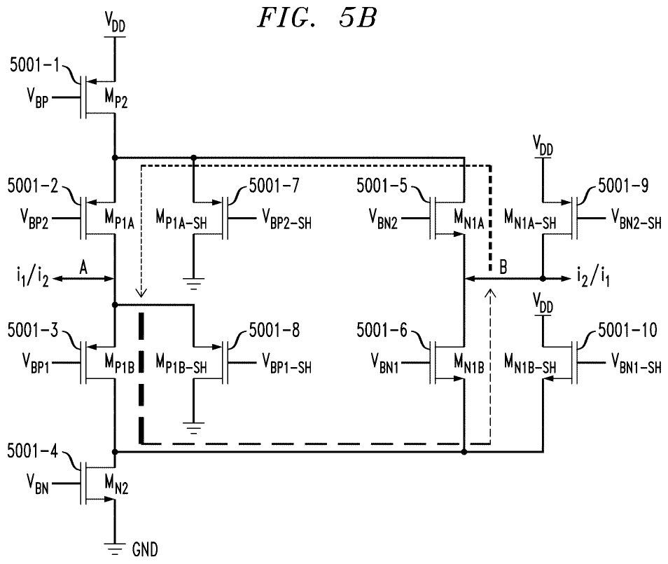

Current mode MACs in accordance with one or more embodiments advantageously provide inherent linearity and reconfigurability. Signal processing can be related to the accuracy and scalability of a current source. Dynamic current sources can be switched ON and OFF in a manner similar to digital logic. Subthreshold operation requires V_{GS}<V_{T}, and V_{DS}>4(kT/q), implying low voltage, low power, and the possibility of combining multiple functionalities within the same supply headroom. Note that V_{GS} is gate-source voltage, V_{DS} is drain-source voltage, and V_{T} is threshold voltage. Furthermore, kT/q is the thermal voltage at absolute temperature T, k is Boltzmann's constant, and q is the value of the charge on the electron. As used herein, V_{T} denotes the threshold voltage, while Vₜ represents thermal voltage, kT/q. Current mode architecture in accordance with one or more embodiments makes it easy to perform linear operations such as addition, subtraction, and multiplication by scalar quantities. In one or more embodiments, a current mode interface leads to higher bandwidth, and multiple outputs can be easily combined. Division by a scalar is also easy to implement in one or more embodiments, and easily reconfigurable. Hierarchical multiplication is also easy to implement in one or more embodiments, according to [α*Σ(xᵢ, wᵢ)]*[β*Σ(xⱼ, wⱼ)]* . . . . See, for example, discussion of FIGS. 7-9 below.

One or more embodiments employ a current comparator implemented by pull up/pull down digital-to-analog converters (DACs) (a flash type comparator can be employed to achieve low latency and low power). In at least some cases, operating in the subthreshold biasing regime leads to low current consumption, and low headroom, in turn leading to stacking functional blocks without a reduction in dynamic range, and thus to a better trade space as compared to simple digital scaling.

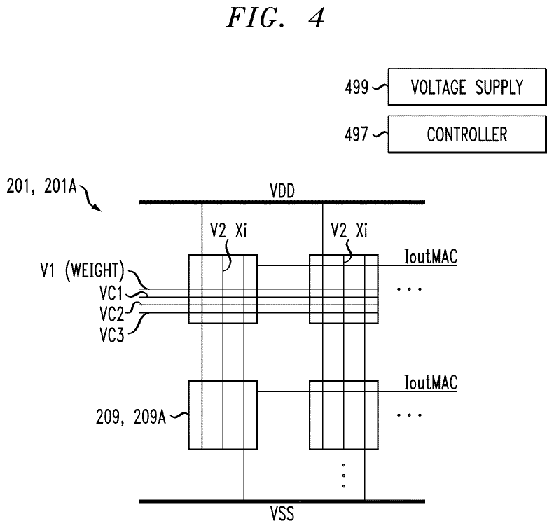

Indeed, in one or more embodiments employing current mode MAC functionality, current sources can be biased in the subthreshold region, i.e., biasing with V_{GS}<V_{T}. Turning the current sources ON and OFF involves charging the gate capacitances to much lower voltages, in turn involving low energy MAC operations. In one or more embodiments, scalar multiplication can be implemented by steering currents (refer, for example, to discussions herein of the bidirectional circuits of FIGS. 5A and 5B). A current mode interface is provided to the comparator 203, and the comparator is constructed to operate in the current mode. One or more embodiments do not require any additional digital logic, and employ a flash type comparator.

It is worth noting that in a non-limiting example, embodiments can be implemented using nanosheet (NS)-FET based technology.

Referring again to FIG. 2B, consider the hybrid MAC block 201, the current mode interface 207, and the current mode slicer (current mode comparator) 203. Hybrid MAC block 201 includes unit cells for carrying out the MAC operation to obtain:

Y=α*Σⱼ₌₀^{k}xⱼwⱼ

The MAC block 201 can have, for example, a 4/6 bit configuration ( 16/64 units). In such a case, the current mode slicer (current mode comparator) 203 can accordingly have 15/63 comparators. In the MAC block 201, using dynamic current sources, the gates only need to charge up to small voltage levels (e.g. one third or one fourth of the supply voltage), thus implying lower energy usage (e.g. reducing from energy consumption of 1 nJ to 100 pJ). Transistors MIA, MIB, . . . MIN (numbered 2001-1, 2001-2, . . . , 2001-N) degenerate transistors M_{2A}, M_{2B}, . . . M_{2N} (numbered 2002-1, 2002-2, . . . , 2002-N) and reduce noise. The MAC is simply the sum of currents from the degenerated sources. Each unit is enabled when S₁ or S₃ is ON, and S₂ is OFF. In one or more embodiments, no capacitor is used, thus implying a very small area (e.g. <25 μm²). When S₃ is ON, M¹ is configured in a self-biased current source with S₃ offering a large (˜10 kΩ) resistance. When S₁ is ON, the corresponding M_{1A}, M_{1B}, . . . M_{1N} (numbered 2001-1, 2001-2, . . . , 2001-N) is configured in linear resistance mode which provides V₁ to the gate of the corresponding M_{1A}, M_{1B}, . . . M_{1N}. The switches S1, S2, and S3 can be implemented by the skilled artisan in a known manner; for example, using FETs as switches and turning them ON and OFF via appropriate gate-source voltage values supplied by VC1, VC2, and VC3 as discussed elsewhere herein.

Element 203 includes the cross-coupled inverters formed by PFETS 2019, 2025 and NFETS 2021, 2027. Each of the FETS 2019, 2021, 2025, 2027 has a first drain-source terminal, a gate, and a second drain-source terminal. The first drain-source terminals of FETS 2019, 2025 are coupled to FETS 2005, 2007, respectively, of element 207, as shown. PFETS 2011, 2015 each have a first drain-source terminal, a gate, and a second drain-source terminal. The first drain-source terminal of each is coupled to VDD and the gate of each is clocked with clock signal CLK. The second drain-source terminal of PFET 2011 is coupled to the node ON formed by the coupled second drain-source terminal of PFET 2019, first drain-source terminal of NFET 2021, and gates of PFET 2025 and NFET 2027. The second drain-source terminal of PFET 2015 is coupled to the node OP formed by the coupled second drain-source terminal of PFET 2025, first drain-source terminal of NFET 2027, and gates of PFET 2019 and NFET 2021.

PFETS 2013, 2017 each have a first drain-source terminal, a gate, and a second drain-source terminal. The first drain-source terminal of each is coupled to VDD and the gate of each is clocked with the clock signal CLK. The second drain-source terminal of PFET 2013 is coupled to the second drain-source terminal of NFET 2021 and the first drain-source terminal of NFET 2023. The second drain-source terminal of PFET 2017 is coupled to the second drain-source terminal of NFET 2027 and the first drain-source terminal of NFET 2029. NFETS 2023, 2029 each have a first drain-source terminal, a gate, and a second drain-source terminal. The first drain-source terminal of each is respectively coupled to the second drain-source terminal of NFETS 2021, 2027, the gate of each is clocked with the clock signal CLK, and the second drain-source terminal of each is grounded.

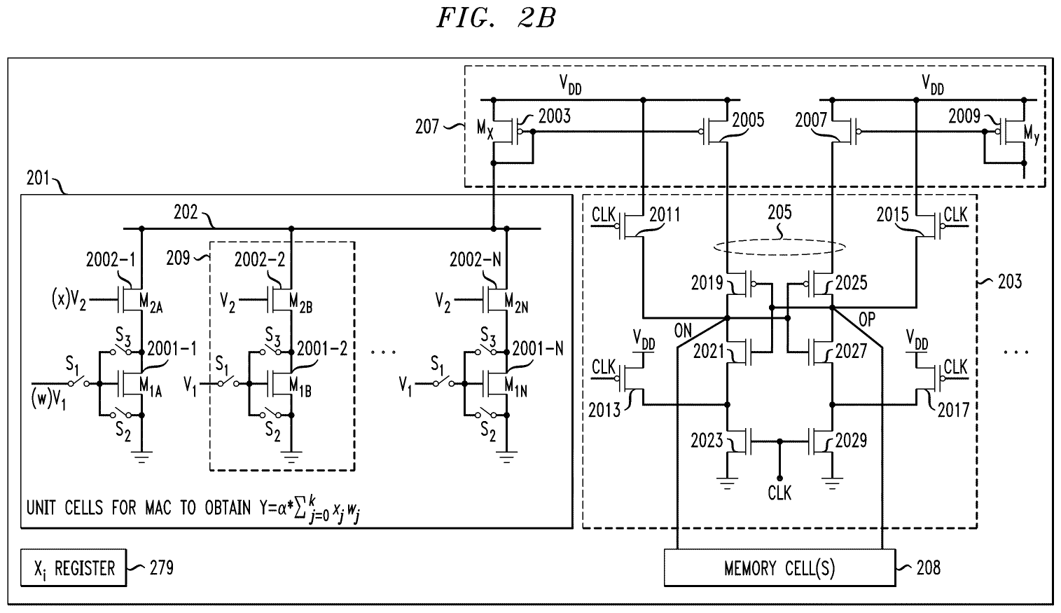

Referring now to FIG. 3, consider now an alternative embodiment of a hybrid MAC 300, providing a current mode interface between the MAC core 201A and the comparator/current mode slicer 303. Element 306 is the (source of) reference current I_{ref}, with respect to which the comparison can be performed. In this aspect, the current mode MAC and current mode comparator reuse the current, and are independently biased by the cascode transistor M3 numbered 3003. Note (“upside down”) cells 209A, voltage rail VDD, and summation line 302. Transistor MIP (numbered 3001-1, . . . , 3001-N) degenerates M_{2N} (numbered 3002-1, . . . , 3002-N) and reduces noise.

Note that the current mirror stage 207 in FIG. 2B can copy the current from left to right and can also implement a scaling factor based on the ratio of the two left-hand transistors (M_{X} 2003 and the transistor 2005 to which its gate is coupled). FIG. 3 removes the mirroring capability and shares the current with the comparator to reduce power consumption of the overall solution. I_{ref} 306 is a reference current similar to that provided by the current source formed by transistors 2007, 2009 but for a known label (CAT, DOG, etc.). The bottom part of FIG. 3 is the same as 203 (memory cell(s) are omitted to avoid repetition). Element 201A is the MAC part for the Xᵢ and Wᵢ, turned upside down with respect to element 201.

Element 303 includes the cross-coupled inverters formed by PFETS 3019, 3025 and NFETS 3021, 3027. Each of the FETS 3019, 3021, 3025, 3027 has a first drain-source terminal, a gate, and a second drain-source terminal. The first drain-source terminals of FETS 3019, 3025 are respectively coupled to FET 3003 and reference current source 306. PFETS 3011, 3015 each have a first drain-source terminal, a gate, and a second drain-source terminal. The first drain-source terminal of each is coupled to VDD and the gate of each is clocked with clock signal CLK. The second drain-source terminal of PFET 3011 is coupled to the node ON formed by the coupled second drain-source terminal of PFET 3019, first drain-source terminal of NFET 3021, and gates of PFET 3025 and NFET 3027. The second drain-source terminal of PFET 3015 is coupled to the node OP formed by the coupled second drain-source terminal of PFET 3025, first drain-source terminal of NFET 3027, and gates of PFET 3019 and NFET 3021.

PFETS 3013, 3017 each have a first drain-source terminal, a gate, and a second drain-source terminal. The first drain-source terminal of each is coupled to VDD and the gate of each is clocked with the clock signal CLK. The second drain-source terminal of PFET 3013 is coupled to the second drain-source terminal of NFET 3021 and the first drain-source terminal of NFET 3023. The second drain-source terminal of PFET 3017 is coupled to the second drain-source terminal of NFET 3027 and the first drain-source terminal of NFET 3029. NFETS 3023, 3029 each have a first drain-source terminal, a gate, and a second drain-source terminal. The first drain-source terminal of each is respectively coupled to the second drain-source terminal of NFETS 3021, 3027, the gate of each is clocked with the clock signal CLK, and the second drain-source terminal of each is grounded.

Referring again to FIG. 2B, in a non-limiting example, MAC unit 201 has a 6 bit configuration and 64 unit cells (N=64). Current mode interface 207 includes a current mode preamplifier (realized, for example, by the ratio of the current mirrors). Current mode slicer (current mode comparator) 203 includes a current mode strong-arm latch (formed by the cross-coupled inverters). Element 209 outlines a single unit cell.

In one or more embodiments, performance and/or speed are configurable by adjusting and/or programming current using voltages V₁ and V₂. Subthreshold operation leads to V_{DD}<550 mV (V_{DS} of about 104 mV is sufficient), with subthreshold operation only dependent on current. The comparator least significant bit (LSB) requires 2 μA (thus, a total of about 126 μA for 63 comparators). The MAC takes about 3200 nA for six bits, for an additional 400 nA. The comparator LSB requires 2 μA (total of about 30 μA for fifteen comparators), the MAC takes about 750 nA for four bits, for an additional 400 nA. For a four-bit example, the total is about 32 μA (about 20 μW) for a 200 MHz speed (100 femtojoules (fJ) per conversion), with low area (comparable to digital (e.g. <25 μm²)). For a six-bit example, the total is about 130 μA (about 80 μW) for a 200 MHz speed (400 fJ per conversion), with low area (comparable to digital (e.g. <25 μm²)). It is to be understood that these are exemplary results and other embodiments can have different values.

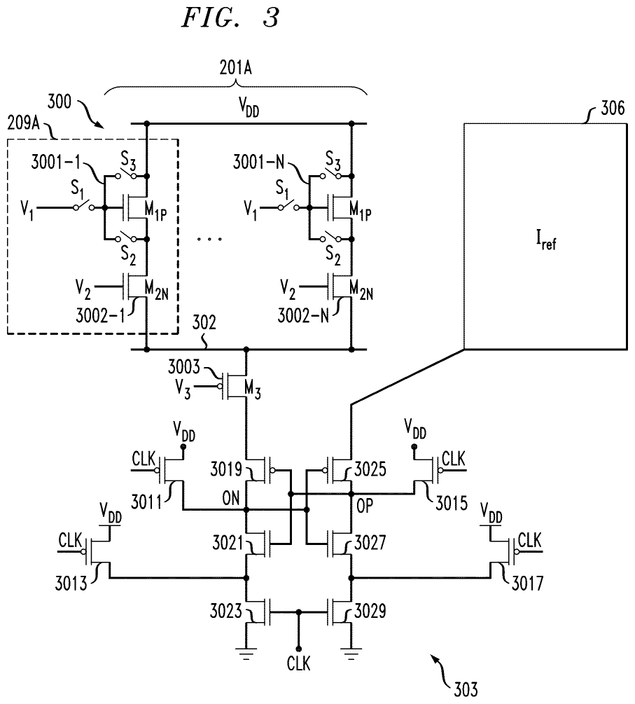

FIG. 4 shows an exemplary portion of an array of unit current cells, which is reconfigurable with respect to input bit width (for lower resolution, approximate computing, and the like). There could, by way of example and not limitation, be an eight by eight array of cells (or any other desired number), as indicated by the ellipses. Current consumption and bit width are digitally configurable.

Still referring to FIG. 4, and referring also back to FIGS. 2B and 3, each cell in FIG. 4 is equivalent to a cell 209 in FIG. 2 or a cell 209A in FIG. 3. For each cell in FIG. 4, coming in from the left are V₁ (weight) and as seen in 201 of FIGS. 2 and 201A of FIG. 3. The other three voltages VC1, VC2, and VC3 control the switches S1, S2, and S3 (e.g., as appropriate gate-source voltage values for FETs implementing the switches). In FIG. 4, note supply VDD, ground VSS, and the middle vertical line labeled “Xi” which is a common line for Xᵢ which connects to V2 as seen in 201 of FIGS. 2 and 201A of FIG. 3 and which, in the depicted examples, comes in from the bottom of the array. The Wᵢ is realized using a vector and a set of two voltages as shown, and appropriate configuration buses run from left to right, as will be apparent to the skilled artisan. Furthermore in this regard, in one or more embodiments, each of the bits can be used as an element of the vector. For example, six inputs X₁ . . . X₆ corresponds to a vector of 6 bits—X is the input vector and there is the weight vector W. In at least some instances, the weights are set by the widths of the corresponding transistors, and the Wᵢ values are used to turn them on and off. In another aspect, the switches S1 S2 S3 can be used to reconfigure the width of the vector. For example, a 6-bit wide core can process an input vector of 6 elements but the MSB (most significant bit) or LSB (least significant bit) could be turned off, for example, to change the resolution to, e.g., 4 bits.

In one or more embodiments, there is a training process to develop the weights, and the matrix 201, 201A is programmed with the weights. In some embodiments, training is done externally (e.g., in software) and then the matrix 201, 201A is programmed with the externally-determined weights and the MAC and decision-making circuits disclosed herein are used for inferencing. On the other hand, in another aspect, the system can train itself. Element 203 is a decision and memory element. It makes a decision about the computed MAC variable, thresholding with respect to a reference current source (e.g., formed by transistors 2007, 2009). That decision is held in the memory 208, and according to those bits and some on-chip post-processing logic, the MAC is updated. Element 203 is a comparator with the MAC result on the left and the reference on the right. Furthermore in this regard, for N bits, there will be 2^{N}−1 comparators (e.g., for 6 bits, 63 comparators). In one or more embodiments, put the comparator output through encoder-like logic that maps the 63 outputs and maps back to a 6-bit vector—the 6 bit vectors are the new vectors that modify the weight vector, taking into account transistor characteristics and process corners. In one or more embodiments, input is digital, processing is analog, and output of the comparator is again digital. In one or more embodiments, digital outputs are processed by digital logic and the output of that digital logic is also digital. In this manner, iteratively determine the weight vector.

In typical embodiments, there will be many elements 203, not merely one. A decision is made by those many elements 203, yielding multiple bits. Suitable decode logic reconstructs the Wᵢ values. In one or more embodiments, in the backpropagation part of training 287, logic is employed, based on the decisions of the array of 203; that/those decision/decisions will go through the logic and the output of that logic will be interfaced with 201. This continues until the convergence criterion is reached. During this training process, the output current of 201 is compared with a reference current from the right branch of 205. The left branch of 205 carries the MAC information. In typical embodiments, there are many comparators for each MAC. Suppose, for example, that the MAC output can range from 0 to 255. There can be multiple levels. For example, determine whether it is between 0 and 15, 16 and 31, 32 and 47, and so on. The MAC value can be quantized according to those levels.

To summarize, in one or more embodiments, there is an analog output for the MAC and it is quantized using the comparators. All the operations, including memory storage/retrieval, can be done in current mode. The memory can be realized, for example, using magnetic MRAM. For example, one or more suitable memory cell(s) 208 can be coupled to nodes ON and OP (via peripheral circuitry, omitted to avoid clutter). In one or more embodiments, the memory 208 can hold the Wi values. In one or more embodiments, a register 279 holds the Xi values; e.g., a first-in-first-out register, sampling latch, or the like. Similar registers could be used in other embodiments. The skilled artisan, given the teachings herein, can adapt known techniques to provide Xi and Wi values to the cells in FIG. 4 from the memory 208 and register 279.

Training: one or more embodiments make use of training vectors; for example, a set of images. For a first image, construct input vectors Xᵢ and initialize the Wᵢ to a certain predetermined value; say, all zeroes or all ones, or some middle value. Compute the summation of Wᵢ and Xᵢ. The expected output is known, corresponding to a specific Xᵢ. The output of the memory cell(s) is examined, and the expected bits for the comparison are known; in one or more embodiments, keep adjusting Wᵢ until outputs close enough to the expected values for that image are obtained. Given the teachings herein, the skilled artisan can heuristically determine when the outputs are “close enough” based on the desired accuracy for a given domain. This storing and updating of weights proceeds in a loop, as described with respect to FIG. 2A. Once satisfactory results are obtained, the current training is complete and the weights can be read out for use in inference for the MAC operation Xᵢ*Wᵢ. A similar process can be done for a second image, etc., up to n images yielding n words. Now, the trained network knows how to apply the right word to an unknown image—the system looks for correlation—does the unknown image match image 1, image 3, . . . ; does it seem like a combination of images 1 and 3; . . . . The transistor carrying the weight and the transistor carrying the Xᵢ are interchangeable (compare 201 to 201A).

The system can train itself and then store the vectors as Wi for n images. In the example of FIG. 2B, the Xᵢ (shown in the figure simply as x) is applied to the top transistor and the appropriate weight, w, is applied to the bottom transistor. One or more embodiments carry out forward propagation and backpropagation as in any other neural network. Thus, during training, use the comparator 203 to determine if the computed result is sufficiently close to the known correct result from the training data. If yes, store those weights for inferencing; if not, perturb the weights, loop back, and try again. During training, memory cell 208 stores the weights and the outputs compared to the image training data (note that image processing is only one example of an application of one or more embodiments; generally, memory 208 stores a set of representative data/data frame that represents a physical variable). This accommodates latency between the forward and backward propagation during training.

Adjusting the weights: in one or more embodiments, the weights are adjusted by using switches S1, S2, and S3. S1 allows the transistors to conduct current. S3 configures the transistor in a self-biased mode so that no external voltage is needed. S2 turns the transistor off. S1 and S2 are complementary: when one is ON the other is OFF and vice-versa. There are thus three modes:
(i) S1 ON S2 OFF S3 OFF: transistor is active and operated in saturation (ON, not self-biased) and mirrors current from reference—all the cells are ganged together to a reference V1.
(ii) S1 OFF S2 ON S3 OFF: transistor (an NMOS is shown) is OFF (not self-biased)—in general, depending on the weight vector, some cells are ON and some cells are OFF.
(iii) S3 ON S1 OFF S2 OFF: transistor is ON in self-biased mode.

Thus, two modes of operation (self-biased and current mirror), and an OFF state configuration yields three reconfigurable states from three switches. In one or more embodiments, the weights are either a zero or a one, with no intermediate values. In one or more embodiments, the inputs Xᵢ are also quantized to zero or one. For example, suppose there are two digital vectors, one representing the signal (e.g., a specific image) and one the algorithmic weight extractor (Wᵢ). Inside the analog core 201, those two multiplications are being done in analog/current mode, but the (one) output is digital as are the (two) inputs.

Inferencing: suppose training has occurred using eight (8) images; the weight vectors have been stored for all eight (8) images, and the expected output word is known. During inferencing, an unknown image is input and an attempt is made to calculate the outputs—it is seen how closely the output for the unknown image matches any of the known solutions. The system looks for the closest match, and that is the label. During inferencing, comparator 203 compares the output for the unknown features (say the image of a DOG) to the outputs for the known features (say images of CAT, DOG, COW, ELEPHANT, LION, TIGER, . . . ). Look for the sum of pixel distance between the unknown image and the known images. During inferencing, use the values stored in the memory cell(s) 208 during training. In one or more embodiments, during inferencing, it is not necessarily required to store anything new. However, if desired, the weights can be updated based on the results of the inferencing. In a non-limiting example, suppose the system was trained on a set of known features (e.g. images of DOGS and BIRDS), and the system needs to be trained with a new object (say the image of a KANGAROO). In this case, after the MAC computations and comparisons, no closest features are found (e.g., the distances from all the previously known features are larger than the acceptable threshold), and the image of kangaroo is added to the feature set.

FIG. 5A shows an exemplary bidirectional current mode input/output (I/O) structure that can be used for computation, according to an aspect of the invention. The example circuitry uses a fully current mode construct with bidirectional current mode input and output with nearly the same common mode. Advantageously, it retains all the beneficial properties of current mode architecture (e.g., low impedance for superior distortion and higher bandwidth (low latency)), plus seamless addition and subtraction. One or more embodiments provide Y=ΣαX(t), where a is realized using segmentation on transistor M_{N1A}, numbered 5001-5. One or more embodiments optionally provide current scaling and steering capability, as discussed with respect to FIG. 5B.

The circuit depicted in FIG. 5A is thus a bidirectional current mode current conveyor, optionally with scaling, which can be used for two purposes, for example. If it is desired to carry out a summation of a very large vector, many pieces of hardware, unit cells, Wi, and the like are needed, so that the solution potentially becomes quite unwieldy. One purpose of the circuits of FIGS. 5A and 5B is to realize a cascade of multiple smaller cells of the MAC. Suppose that it is desired to use an 18-bit vector for training and other purposes (say, for automation). However, suppose a cell is available that can process only six bits at a time. In one or more embodiments, cascade three of the six bits to realize what is essentially an 18-bit type of engine. One MAC array 201, 201A can directly communicate with another MAC array 201, 201A, with bidirectional features to support both forward propagation and backpropagation. The circuits of FIGS. 5A and 5B can thus function as a bridge which allows one MAC array to communicate with another MAC array, so that the information can flow both forward and backward. The currents i₁ and i₂ are the input and output currents. The top and bottom transistors operate with some current. In the case of current from the left propagating to the right, current passes through the two bottom transistors M_{P1} 5001-3 and M_{N1B} 5001-6. The current coming from the left “sees” that the top M_{P1} 5001-2 has a very high output impedance, so it does not follow that path, but it “sees” a low impedance path in the bottom transistor. Thus, the current flows through the drain of that transistor but then “sees” a high impedance at the output of the M_{N2} 5001-4 at the bottom, so the current passes through the lower M_{N1B} 5001-6 and to the output. M_{P1} 5001-3 is shown with an arrow (variable); this means there is a transistor in parallel with it (e.g. 5001-8), which can “dump” a part of the current to ground. Thus, the circuits of FIGS. 5A and 5B can function as both a current comparator and a linear current scaler, without any linearity penalty (low distortion as both input and output are currents).

A pertinent aspect of one or more embodiments is that MAC is carried out in current mode and a low latency multi-core MAC operation can be enabled by the scaling and bidirectional current comparator of FIGS. 5A and 5B. Referring again to FIG. 2B, in one or more embodiments, there can be multiple arrays 201 before connecting to element 207. The circuits of FIGS. 5A and 5B can be located between two adjacent MAC arrays 201 (or 201A)(or between elements 201 and 207 in FIG. 2B). It will be appreciated that, classically, analog signal processing is viewed as a low power option as compared to digital signal processing, because it compacts the information—instead of a number of bits, N, to represent information, as in digital, a single analog wire is employed to carry all the information that would otherwise take N bits (and thus, N wires). One or more embodiments advantageously represent information using the amplitude of a single continuous time analog signal on a single wire, without any loss of information.

FIG. 5B shows the details of an exemplary bidirectional current cell. The input to this cell is denoted as i₁, and the output is denoted as i₂. Various bias voltages {V_{BP1}, V_{BP2}, V_{BN1}, V_{BN2}} are used in order to keep the respective transistors (e.g. M_{P1B}, M_{P1A}, M_{N1B} and M_{N1A}) in the saturation mode of operation, and the other set of bias voltages {V_{BP1-SH}, V_{BP2-SH}, V_{BN1-SH}, V_{BN2-SH}} are used to shunt a part of the current to the supply rails (e.g. VDD and GND). The amount of current that is passed from the input and output depends on the differences of the gate bias voltages between the main transistors M_{P1/2} and their respective shunt equivalents (e.g., M_{P1-SH/2-SH}).

For illustrative purposes, the input and output paths are shown using different line thicknesses to illustrate the operation of the bidirectional current conveyor. When the input is from the left side (shown in dashed lines), a part of the current flows through the transistor M_{P1B}, in response to the voltage difference between V_{BP2} and V_{BP-SH}. The main bias voltages V_{BP} and V_{BPN} are set in order to provide a static bias current through the stack of M_{P2}, M_{P1A}, M_{P1B}, M_{N2}, which is larger than the input current. These voltages may be derived from a replica biasing scheme or simply digitally adjustable. Another current scaling can occur using the two transistors M_{N1A} and M_{N1A-SH}. Similarly, when the input is applied from the right side (shown in dotted lines), the output is from the left and the two scalars can be realized using transistors M_{N1A}, M_{N1A-SH}, M_{P1A}, M_{P1A-SH}.

In one or more embodiments, there are two mechanisms by which current scaling can be accomplished. First, a transistor can be segmented and a selected set can be enabled out of a total set of transistors. As an example, a transistor can be segmented (e.g. its total width divided into N parts) and a few of the parts (e.g. M, where M<N) are selected to conduct a current which is a fraction of the input current. This approach provides current scaling at constant current density (e.g., amount of current is proportional to the total width of the transistor that is selected). Another mechanism (suitable for high frequency operation) is to create a systematic offset between the gate voltages of the companion pair (e.g. V_{BP2} and V_{BP2-SH}) so that one side is “more ON” compared to the other side, and the current is scaled depending on the voltage difference and the square law characteristics of the transistors.

Hence, there are two places where the current can be scaled. At least some embodiments include a scheme where the input and output common modes are invariant in the way that each path includes an addition and subtraction of the drain to source voltages, which become substantially equal so that they both cancel each other. There is thus, in one or more embodiments, a benefit of input and output common mode—the way the signal processing works, if any variables are taken from Point A to Point B, when it is desired to create any connection between A and B, it is desirable to ensure that DC voltage (e.g. DC compatibility) is held the same. For example, one can “put” B to another circuit without connecting B; this creates a bidirectional switch so one can seamlessly go from one core to another. Bidirectionality can be achieved in a way such that the DC voltage remains the same—so one can seamlessly connect a MAC core to another MAC core. Hence, this structure becomes attractive for scaled CMOS nodes.

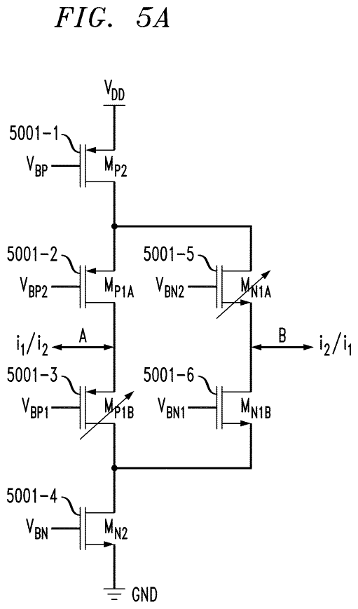

FIG. 6 shows an exemplary extension of aspects of the invention to radio frequency (RF) MIMO arrays (for example, waking a receiver (Rx) for tiny ML applications). As will be appreciated by the skilled artisan, in radio, multiple-input and multiple-output, or MIMO, is a method for multiplying the capacity of a radio link using multiple transmission and receiving antennas to exploit multipath propagation. MIMO is used, for example, in Wi-Fi (IEEE 802.11) and cellular telephone networks.

In FIG. 6, each small box in the large box corresponds to a cell such as 209 (cells 209A could also be employed). The φ values are the different phases of the MIMO antenna. In radio frequency (RF), some amount of power is received, using antennas, and is converted to both voltages and currents (usually, one or the other is emphasized). Take the inputs from an antenna and pass through a mixer. The mixers are used as current commutators (i.e., current mode switches; can also be referred to in this context as downconverters and upconverters); they provide the output currents. Those currents are summed together via the MAC operation in block 6999, and the result is compared with a known reference. This is similar to the other application(s) described herein, but here, there are mixer stages 6001-1, 6001-2, 6001-3, . . . , 6001-N placed before the MAC operation block. The mixers are used to translate information from one frequency to another. The Xᵢ are the inputs from the received signal. The Y values are the local clock waveforms with different phase components, having the same frequency. The outputs of the mixers include the difference of two frequencies and the sum of two frequencies. Thus, in FIG. 6, the left side mixers 6001-1 . . . essentially function as peripheral circuitry, taking information at a given frequency and translating to a lower frequency at which the MAC core operates. The right side mixers 6003-1 . . . also perform a frequency shift.

In one or more receive mode embodiments, the difference of the two frequencies is of interest and the sum is filtered out. A transmit mode, where the sum is of interest, and the difference is filtered out, is also possible. As long as two frequencies, f1 and f2, are close together, if the mixing operation is a multiplication operation, by definition, what is obtained is the sum and difference of the two frequencies. If f1 and f2 are equal, maximize the difference between the sum and the difference since the sum would be 2f and the difference would be zero (DC). However, owing to the presence of flicker noise and DC offsets in various circuit interfaces, it is preferable to operate with a small value for f1−f2 (from 100 kHz to 1 GHZ) and maximize the ratio between |(f1+f2)/(f1−f2)| (typically ˜10 or higher). A large ratio allows an easy realization of the on-chip filter for improving the signal to noise ratio (SNR). For example, in the case of 5 GHz and 4 GHz (25% difference), the sum is 9 GHz and the difference is 1 GHz (900% difference). This is helpful with respect to filtering and the like. A filtering mechanism can be provided on-chip. Embodiments with both transmit and receive modes are possible.

Consider a multiple antenna based transceiver shown in FIG. 6 where the delay elements (phase shifting elements for narrowband systems) can be adjusted to change the direction of a beam. Information can be focused on a point in the 3D space by changing the relative amplitude and phase relationships among the beams. Such a system can be trained using a set of features (e.g., mountainous terrain, oceanfront, a highly populated city etc.). If it is required to create a landscape with the orders interchanged (in the 3D space) it is possible to do so, using a different sequence of phase arrangements of the LO vector Z. It is also possible to determine whether the map of a known object (e.g. map of a city) resembles an image constructed using the known images. This can be detected by using the MAC block 6999 and comparator circuitry. Note the antennas (not separately numbered) that can optionally be coupled to the left side mixers 6001-1 and the right side mixers 6003-1.

When the circuit of FIG. 6 is operating in a receive mode, carry out the MAC operation, obtain an output for each row, and mix with the local oscillator waveforms (marked by variable Z), each having the same frequency but with different phase. The waveforms from the current processor units are upconverted using mixers 6003-1, 6003-2, 6003-3, . . . , 6003-M to obtain U₁, U₂, . . . U_{M}. The unit in FIG. 6 can be, for example, a repeater or a transponder. In one or more embodiments, it receives a signal from one direction and outputs the signal in different directions (based on the values of the phases in the variable Z). In one or more instances, the left side is a receiver. It performs the MAC operation, applies threshold(s), and if it scans, say, 140 degrees of beamforming, it has captured a certain function. One or more embodiments find the function that matches and relay the information in other directions on the right side, which acts like a transmitter in one or more embodiments. This is one exemplary operation. The mixer multiplier is an array of switches. Switches are, by definition, bidirectional; if coupled with a peripheral circuit that is bidirectional it enhances the signal processing capability of a much larger system. The right side could be configured as a receiver and the left side as a transmitter, for example. With a bidirectional core and a bidirectional peripheral scheme, the functional definition of transmitter and receiver are also interchangeable.

One or more embodiments provide a current-mode multiply, accumulate and compare (MACC) core 201, 201A operating on a digital input word X and a digital weight vector W, an input current (e.g., from current source(s) as discussed), and an input clock CLK. One or more embodiments compute a digital output word Y. One or more embodiments employ the current mode multiply and accumulate core with a current divider, a current mode comparator unit, and appropriate latches for valid data input and output.

The multiply and accumulate unit can include, for example, a plurality of multiplier units that provide an output current given by the equation Iₒᵤₜ=Xᵢ*Wᵢ*I_{ref}, where Xᵢ and Wᵢ assume digital values; the outputs of all the individual units are summed in current mode. The output current is scaled in amplitudes and provided to a current mode comparator. A thresholder unit generates a reference current (e.g. from 2007, 2009 or I_{ref}) for comparison; thresholding can essentially be embedded within the activation function.

One or more embodiments are fully programmable using a digital control word and are dynamically configurable. In at least some cases, the multiplier core is biased in weak inversion.

In one or more embodiments, a cascade of current mode AI cores use N stages, where the first N−1 cores provide output current using an alternate current source/sink topology, and the Nth stage provides the computed variables. In at least some cases, the input vectors are provided concurrently to multiple AI cores and multiple decisions are available simultaneously.

Indeed, one or more embodiments provide a current mode multiply and accumulate unit including a current mode multiply and accumulate core, a current mode storage unit (e.g. MRAM), and a bias control unit (e.g., voltage supply, controller). In another aspect, a bidirectional current mode MAC core is provided, wherein the direction of the current and the scaling factor can be adjusted using digital control, the bias current density can be adjusted using digital code, and code for mismatch correction can be stored in the storage element.

In at least some cases, a current mode interface is used between the MAC and the current comparator. Decisioning is performed, for example, either using a current comparator or a voltage comparator after a trans-impedance amplifier. Common digital controls are provided to compensate for P, T variations for the entire array. In at least some cases, the interface from one MAC to another MAC is performed in current mode, and no digital conversion needs to be performed in a single MAC slice.

Advantageously, one or more embodiments provide a current mode MAC for AI applications, with current mode memory, low latency, a seamless interface with MRAM with low area footprint, current mode computation in memory interface where both the MAC and memory are both current mode, bias density adjustment using digital codes for P,T variation and current density control for low power and low latency while operating at the desired level of mismatch, and/or bidirectional current mode MAC core, leading to easy interface and low latency training in the array.

Non-limiting exemplary applications include a MAC core (also referred to as an array), tiny ML, RF beamformers, and the like.

In one or more embodiments, MRAM operates in current mode. There are many ways the biasing can be accomplished, for example: (a) establishing a common mode biasing at the MRAM node (which can be accomplished, for example, by a simple source follower bias, or common mode feedback if the drain node is used for the interface); (b) common mode feedback if the circuit is differential; (c) by inherent current slicing. Regarding the latter, say the computed current is I1 which varies between I1H (high) and I1L (low), and a DC current subtractor is used with a value of 10, so {I1H−I0} can represent a state 1 and {I1L-I0} can represent a state 0. This way, the interface between the MAC and MRAM is seamless.

In one or more embodiments, as the implementation is current mode, current scaling can be easily performed using current steering (e.g., a shunt transistor associated with one of the transistors in the stack and controlling the gate voltage digitally).

Regarding dynamic range, an exemplary embodiment is designed for six-bit unary for one version and an eight-bit unary for another version. Monte Carlo (MC) simulations indicate a loss of up to one bit or so, so the true number of bits would be 5.5 and 7 bits, respectively.

It is believed that, using a static code sweep, the nonlinearity can be characterized in an in-situ measurement, and the threshold can be adjusted to compensate for the mismatches. Another suitable technique is pre-distortion, where the input code can be adjusted to provide an inverse transformation on the data.

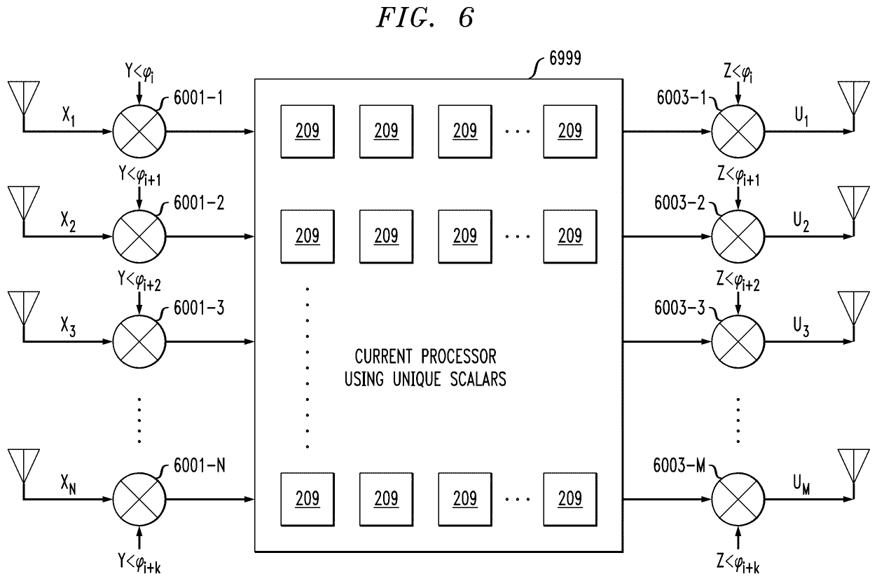

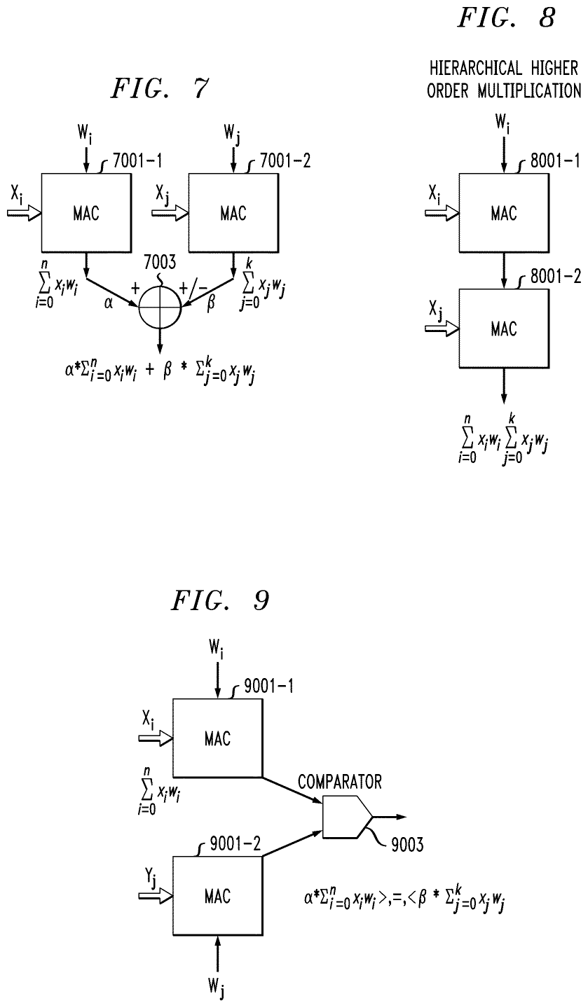

FIGS. 7-9 depict certain pertinent functional macros. FIG. 7 shows the use of two MAC units to implement a linear algebraic equation (including addition and/or subtraction). Vector mode processing can be carried out if Xᵢ, Xⱼ are shifted by quadrature phase. FIG. 8 shows implementing hierarchical higher order multiplication with two MAC units. FIG. 9 shows two MAC units connected to a comparator, with easy implementation in current mode (simple connection of two wires, fast operation), which can be used for ADC implementation.

FIG. 7 shows two MACs whose currents are scaled with respect to a and B. Vector processing is realized with respect to the two MACs. α*A+β*B can be realized. FIG. 7 thus shows a weighted MAC operation out of two independent MACs. FIG. 8 shows a cascade of two MACS (FIG. 8 is shown unweighted but weights could be applied). One processes with respect to one vector. The output of that MAC is processed with respect to the other vector (a multiplication within a multiplication). Thus, by cascading two MACs in current mode, nested operations can be carried out. Each MAC in FIGS. 7-9 is a unit 201 or 201A. FIG. 9 shows two MACS with their outputs as inputs to a comparator.

Given the discussion thus far, it will be appreciated that, in general terms, an exemplary apparatus, according to an aspect of the invention, includes a current-mode multiply-accumulate (MAC) core 201, 201A including a plurality of parallel current carrying paths 209, 209A. Each path is configured to carry a unit current based on a state of an input variable x, a weight w, and a configuration vector, which sets the configuration of the three switches as described elsewhere herein. The plurality of current carrying paths are arranged in groups (e.g., rows); each group has a summation line 202, 302.

Also included are a plurality of current mode interfaces; each current mode interface of the plurality of current mode interfaces is coupled to a corresponding summation line of the plurality of summation lines. Examples of current mode interfaces include ordinary wires, interface 207 as shown in FIG. 2A, a bidirectional buffer such as shown in FIGS. 5A and 5B, or an isolating transistor M3 positioned as in FIG. 3. Note that in FIG. 3, the comparator and current mode summation share current together.

Further included are a plurality of current mode comparators 203, 303 coupled to the plurality of current mode interfaces and configured to compare current on the corresponding one of the plurality of summation lines to a plurality of corresponding reference currents (supplied, for example, from current sources as described below). In one or more embodiments, there is one interface per summation line, one comparator for each interface and summation line, and each one has its own reference current.

In one or more embodiments, the current-mode multiply-accumulate (MAC) core includes a plurality of summation lines 202, 302, IoutMAC in FIG. 4; a plurality of first input voltage lines, V1 weight in FIG. 4; and a plurality of second input voltage lines, V2 Xi in FIG. 4. Further, the plurality of parallel current carrying paths are configured as a plurality of current-mode cells 209, 209A. Each of the plurality of current-mode cells includes: a vector element input field effect transistor 2002-1 or 3001-1 having a first drain-source terminal, a gate, and a second drain source terminal; and a weight field effect transistor 2001-1 or 3002-1 having a first drain-source terminal coupled to the second drain-source terminal of the vector element input field-effect transistor, a gate, and a second drain source terminal. The skilled artisan will appreciate from the drawings when a drain-source terminal is functioning as a drain and when it is functioning as a source.

In one or more embodiments, the gate of the vector element input field effect transistor is coupled to a corresponding one of the plurality of second input voltage lines; the gate of the weight field effect transistor is coupled to a corresponding one of the plurality of first input voltage lines; and the first source-drain terminal of the vector element input field effect transistor is coupled to a corresponding one of the summation lines.

One or more embodiments include a first voltage rail, VDD in FIG. 4; a second voltage rail, VSS in FIG. 4; and a plurality of control voltage lines arranged in rows, VC1, VC2, and VC3 in FIG. 4. The plurality of summation lines, the plurality of first input voltage lines, and the plurality of control voltage lines are arranged in the rows; refer to IoutMAC in FIG. 4, V1 weight in FIG. 4, and VC1, VC2, and VC3 in FIG. 4. Furthermore, the plurality of second input voltage lines are arranged in columns, V2 Xi in FIG. 4; and the rows and columns intersect at a plurality of cell locations where the plurality of plurality of current-mode cells are located. One or more embodiments further include a plurality of first voltage supply lines arranged in the columns and coupled to the first voltage rail, vertical VDD line in FIG. 4; and a plurality of second voltage supply lines arranged in the columns and coupled to the second voltage rail, vertical VSS line in FIG. 4. In one or more embodiments, each of the current mode cells further comprises a switch network S1-S2-S3 coupled to the weight field effect transistor and coupled to a corresponding one of the plurality of first input voltage lines; and the second drain-source terminal of the weight field effect transistor is coupled to one of the first and second voltage rails.

Referring to FIG. 2B, in one or more embodiments, the weight field effect transistor is a lower transistor relative to the vector element input field effect transistor; and the second drain-source terminal of the weight field effect transistor is coupled to the second voltage rail (e.g., ground/VSS). In some cases, the weight field effect transistor and the vector element input field effect transistor comprise n-type field effect transistors.

In one or more embodiments, the switch network is configured to: render the weight field effect transistor ON, as an active current mirror, in a non-self-biased first mode; render the weight field effect transistor OFF in a non-self-biased second mode; and render the weight field effect transistor ON, in a self-biased third mode, as discussed elsewhere herein.

As shown in FIG. 2B, one or more embodiments further include a plurality of reference current sources (e.g., formed by transistors 2007, 2009) configured to provide the plurality of corresponding reference currents.

Referring to FIG. 3, in one or more embodiments, the weight field effect transistor is an upper transistor relative to the vector element input field effect transistor; and the first drain-source terminal of the weight field effect transistor is coupled to the first voltage rail (e.g., VDD). In some cases, the weight field effect transistor and the vector element input field effect transistor comprise n-type field effect transistors.

In one or more embodiments, the switch network is configured to: render the weight field effect transistor ON, as an active current mirror, in a non-self-biased first mode; render the weight field effect transistor OFF in a non-self-biased second mode; and render the weight field effect transistor ON, in a self-biased third mode, as discussed elsewhere herein.

One or more embodiments further include a plurality of reference current sources 306 configured to provide the plurality of corresponding reference currents.

In general, one or more embodiments further include a voltage supply 499 and a controller 497. Voltage supply 499 can be any known voltage supply circuitry for microelectronics as familiar to the skilled artisan; the connections are omitted in FIG. 4 to avoid clutter. The controller 497 can be realized in digital logic, for example, and the connections are omitted to avoid clutter. Controller 497 is configured to cause: the voltage supply to supply a supply voltage to at least one of the first or second voltage rails (e.g., VDD while the other could be VSS/ground); signals associated with a weight vector to be applied to the plurality of first input voltage lines arranged in the rows (e.g., W, V1; in some instances, can be just on/off with pre-programmed transistor widths); and input signal values to be applied to the plurality of second input voltage lines arranged in the columns (X, V2).

Appropriate switch control voltages (configuration vector) can be applied to set the configuration of the three switches as described elsewhere herein. In one or more embodiments, input from a sensor, such as an IoT sensor, can be applied to the Xi and it causes the MAC to occur and the Yj are obtained on the outputs.

As noted elsewhere, there can be multiple cores 201, 201A. Thus, in some cases, the plurality of summation lines, the plurality of first input voltage lines, the plurality of second input voltage lines, and the plurality of current-mode cells, form a first current mode multiply-accumulate core, and the apparatus further includes a second current mode multiply-accumulate core (which can, for example, be identical to the first) coupled to the first current mode multiply-accumulate core.

In one or more embodiments, each row of each core has a summation line that is connected to a comparator. If it is desired to connect multiple cores, the circuits in FIG. 5A or 5B can be used as a “glue logic” for such connection, for example. In some cases, unlike prior art devices where “fast” MAC cores might be slowed down by peripheral circuitry, in one or more embodiments, configuration switches permit optimizing individual cores, testing one core at a time, and/or dynamic configuration. For example, an FPGA could employ an array of analog current-mode MACs that can be reconfigurable; the bidirectional circuits in FIG. 5A or 5B permit this.

In some cases, the weights can come from the relative strengths of the legs. For example, in one aspect, the weights are realized in the strengths of the transistors on the bottom of the cells in the MAC array 201 (e.g., MIA, MIB, . . . ) of FIG. 2B or the top ones in FIG. 3 (MIP). The current consumption therein determines the weights. In this aspect, for example, MIA and MIB can have different widths; the difference provides the weighting function. This aspect is obtained from the actual fabrication of the circuit. MIA and MIB could also be realized as programmable groups of transistors. In one non-limiting example, train the system in software to develop the weights, fabricate an IoT device with those weights designed into the hardware, and use the device for inferencing.

Now, consider inferencing and the selection of which of the three modes to use. This can be based, for example, on supply voltage, power consumption, and the like. One configuration may have the lowest quiescent current consumption, another the lowest supply voltage, lowest overall power consumption, and so on. The self-biased case will typically have a slightly higher supply voltage, but on the other hand, eliminates additional controls, and thus provides the simplest mode. Input the Xi to the IoT device with the hardware weights and carry out inferencing to obtain Yi. Any of the three switch configurations can be employed to find the linear summation.

Referring now to FIGS. 7-9, one or more embodiments provide an apparatus including a first current mode multiply-accumulate core configured to multiply each of a plurality of elements of a first input vector with first corresponding weights and to sum resulting products of the multiplication; and a second current mode multiply-accumulate core configured to multiply each of a plurality of elements of a second input vector with second corresponding weights and to sum resulting products of the multiplication. The second current mode multiply-accumulate core is coupled to a first current mode multiply-accumulate core.

Referring specifically to FIG. 7, note the first and second cores 7001-1 and 7001-2, and note that the apparatus of FIG. 7 further includes a summation element 7003 (can be implemented, for example, using FIG. 5A or 5B). A weighted output of the first current mode multiply-accumulate core 7001-1 and a weighted output of the second current mode multiply-accumulate core 7001-2 are input to the summation element, and the summation element is configured to sum the weighted outputs of the first and second current mode multiply-accumulate cores.

Referring specifically to FIG. 8, note the first and second cores 8001-1 and 8001-2. Note also that an output of the first current mode multiply-accumulate core 8001-1 is supplied to an input of the second current mode multiply-accumulate core 8001-2, and the second current mode multiply-accumulate core is configured to output a hierarchical product.

Referring specifically to FIG. 9, note the first and second cores 9001-1 and 9001-2, and note that the apparatus of FIG. 9 further includes a comparator 9003. A weighted output of the first current mode multiply-accumulate core 9001-1 and a weighted output of the second current mode multiply-accumulate core 9001-2 are input to the comparator 9003, and the comparator is configured to compare the weighted outputs of the first and second current mode multiply-accumulate cores and output a corresponding logical value. By way of example and not limitation, comparator 9003 may output a logical “one” when a certain condition is satisfied; for example, weighted output of 9001-1 is greater than or equal to, greater than, equal to, less that, or less than or equal to the weighted output of 9001-2. Comparator 9003 may output a logical “zero” when the certain condition is not satisfied. Comparator 9003 may, for example, instead output a logical “zero” when the condition is satisfied and a logical “one” when it is not.

Referring now to FIG. 6, in another aspect, an exemplary apparatus includes a plurality of current mode multiply cells 209 arranged in rows and columns; and a plurality of input mixers 6001-1, 6001-2, 6001-3, . . . , 6001-N. Each input mixer has an output coupled to an input of a corresponding row of current mode multiply cells, and each input mixer has a signal input Xi and a phase component input Y. Also included are a plurality of output mixers 6003-1, 6003-2, 6003-3, . . . , 6003-N. Each output mixer has a signal input coupled to an output of a corresponding row of current mode multiply cells and has a phase component input Z and an output U.

In one aspect, the apparatus of FIG. 6 can operate in a receive-transmit (RX-TX) mode. For example, the apparatus further includes a plurality of receive antennas (not separately numbered) coupled to the signal inputs of the plurality of input mixers and a plurality of transmit antennas (not separately numbered) coupled to the signal outputs of the plurality of output mixers.

Referring now to FIGS. 5A and 5B, an exemplary apparatus includes a first field effect transistor 5001-1 MP2 having a first source-drain terminal coupled to a first voltage rail VDD, a gate, and a second source-drain terminal; a second field effect transistor 5001-2 MP1A having a first source-drain terminal coupled to the second source-drain terminal of the first field effect transistor, a gate, and a second source-drain terminal; and a third field effect transistor 5001-3 MP1B having a first source-drain terminal coupled to the second source-drain terminal of the second field effect transistor, a gate, and a second source-drain terminal. Also included are a fourth field effect transistor 5001-4 MN2 having a first source-drain terminal coupled to the second source-drain terminal of the third field effect transistor, a gate, and a second source-drain terminal coupled to a second voltage rail VSS/GND; a fifth field effect transistor 5001-5 MN1A having a first source-drain terminal coupled to the second source-drain terminal of the first field effect transistor and the first source-drain terminal of the second field effect transistor, a gate, and a second source-drain terminal; and a sixth field effect transistor 5001-6 MN1B having a first source-drain terminal coupled to the second source-drain terminal of the fifth field effect transistor, a gate, and a second source-drain terminal coupled to the second source-drain terminal of the third field effect transistor and the first source-drain terminal of the fourth field effect transistor.

The apparatus also includes a first current mode multiply-accumulate core 201, 201A configured to multiply each of a plurality of elements of a first input vector with first corresponding weights and to sum resulting products of the multiplication. The first current mode multiply-accumulate core is coupled to the first source-drain terminal of the third field effect transistor and the second source-drain terminal of the second field effect transistor.

The apparatus further includes a second current mode multiply-accumulate core 201, 201A configured to multiply each of a plurality of elements of a second input vector with second corresponding weights and to sum resulting products of the multiplication. The second current mode multiply-accumulate core is coupled to the first source-drain terminal of the sixth field effect transistor and the second source-drain terminal of the fifth field effect transistor.

As shown in FIG. 5A, in some cases, the third and fifth field effect transistors are variable strength transistors (e.g., variable width).

As shown in FIG. 5B, one or more embodiments further include a seventh field effect transistor 5001-7 MP1A-SH shunt having a first source-drain terminal coupled to the second source-drain terminal of the first field effect transistor and the first source-drain terminal of the second field-effect transistor, a gate, and a second source-drain terminal coupled to the second voltage rail; an eighth field effect transistor 5001-8 MP1B-SH shunt having a first source-drain terminal coupled to the second source-drain terminal of the second field effect transistor and the first source-drain terminal of the third field-effect transistor, a gate, and a second source-drain terminal coupled to the second voltage rail; a ninth field effect transistor 5001-9 MN1A-SH shunt having a first source-drain terminal coupled to the first voltage rail, a gate, and a second source-drain terminal coupled to the second source-drain terminal of the fifth field effect transistor and the first source-drain terminal of the sixth field effect transistor; and a tenth field effect transistor 5001-10 MN1B-SH shunt having a first source-drain terminal coupled to the first voltage rail, a gate, and a second source-drain terminal coupled to the second source-drain terminal of the sixth field effect transistor, the second source-drain terminal of the third field effect transistor, and the first source-drain terminal of the fourth field effect transistor.

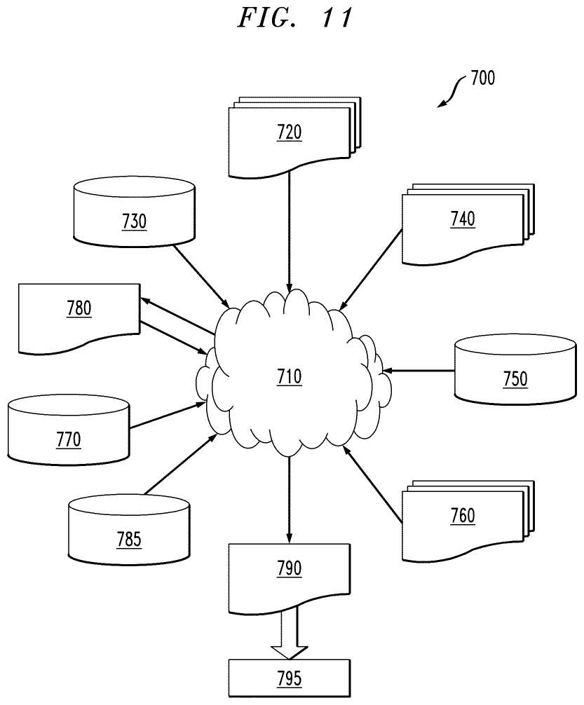

Given the teachings herein, the skilled artisan can implement logic gates, circuit elements, and/or circuits herein using known techniques for logic synthesis, semiconductor design, manufacture, and/or test; see, e.g., FIG. 11 and accompanying text.

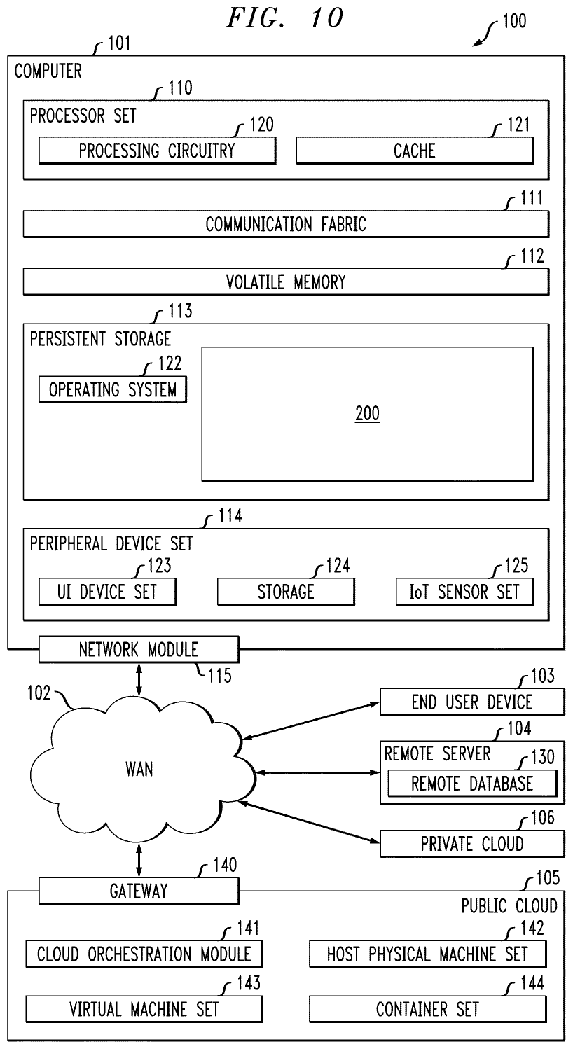

Refer now to FIG. 10, which depicts a computing environment useful in connection with some aspects of the present invention (e.g., representative of a general-purpose computer that could implement a design process such as that shown in FIG. 11; could also represent aspects of an IoT device that could use aspects of the invention as a hardware co-processor for current-mode neural network inferencing).

Computing environment 100 contains an example of an environment for the execution of at least some of the computer code involved in performing appropriate methods (e.g., design process of FIG. 11), as seen at 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 10. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Exemplary Design Process Used in Semiconductor Design, Manufacture, and/or Test

One or more embodiments of hardware in accordance with aspects of the invention can be implemented using techniques for semiconductor integrated circuit design simulation, test, layout, and/or manufacture. In this regard, FIG. 11 shows a block diagram of an exemplary design flow 700 used for example, in semiconductor IC logic design, simulation, test, layout, and manufacture. Design flow 700 includes processes, machines and/or mechanisms for processing design structures or devices to generate logically or otherwise functionally equivalent representations of design structures and/or devices, such as those disclosed herein or the like. The design structures processed and/or generated by design flow 700 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g., e-beam writers), computers or equipment for simulating design structures, any apparatus used in the manufacturing or test process, or any machines for programming functionally equivalent representations of the design structures into any medium (e.g., a machine for programming a programmable gate array).

Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 11 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD) such as implemented by a core developer/designer. When encoded on a gate array or storage medium or the like, design structure 720 may be accessed and processed by one or more hardware and/or software modules within design process 710 to simulate or otherwise functionally represent an electronic component, circuit, electronic or logic module, apparatus, device, or system. As such, design structure 720 may comprise files or other data structures including human and/or machine-readable source code, compiled structures, and computer executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher-level design languages such as C or C++.

Design process 710 preferably employs and incorporates hardware and/or software modules for synthesizing, translating, or otherwise processing a design/simulation functional equivalent of components, circuits, devices, or logic structures to generate a Netlist 780 which may contain design structures such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable data storage medium or programmed into a programmable gate array. The medium may be a nonvolatile storage medium such as a magnetic or optical disk drive, a programmable gate array, a compact flash, or other flash memory. Additionally, or in the alternative, the medium may be a system or cache memory, buffer space, or other suitable memory.

Design process 710 may include hardware and software modules for processing a variety of input data structure types including Netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 740, characterization data 750, verification data 760, design rules 770, and test data files 785 which may include input test patterns, output test results, and other testing information. Design process 710 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes such as timing analysis, verification, design rule checking, place and route operations, etc.

Design process 710 employs and incorporates logic and physical design tools such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g., information stored in an IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on data storage media and that when processed by an ECAD system generate a logically or otherwise functionally equivalent form of one or more IC designs or the like as disclosed herein. In one embodiment, design structure 790 may comprise a compiled, executable HDL simulation model that functionally simulates the devices disclosed herein.

Design structure 790 may also employ a data format used for the exchange of layout data of integrated circuits and/or symbolic data format (e.g., information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein. Design structure 790 may then proceed to a stage 795 where, for example, design structure 790: proceeds to tape-out, is released to manufacturing, is released to a mask house, is sent to another design house, is sent back to the customer, etc.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus comprising:
a current-mode multiply-accumulate (MAC) core comprising a plurality of parallel current carrying paths, each path configured to carry a unit current based on a state of an input variable, a weight, and a configuration vector, the plurality of current carrying paths being arranged in groups, each group having a summation line;
a plurality of current mode interfaces, each current mode interface of the plurality of current mode interfaces being coupled to a corresponding summation line of the plurality of summation lines; and
a plurality of current mode comparators coupled to the plurality of current mode interfaces and configured to compare current on the corresponding one of the plurality of summation lines to a plurality of corresponding reference currents.

2. The apparatus of claim 1, wherein:
the current-mode multiply-accumulate (MAC) core includes:
a plurality of summation lines;
a plurality of first input voltage lines; and
a plurality of second input voltage lines; and
the plurality of parallel current carrying paths are configured as a plurality of current-mode cells, each of the plurality of current-mode cells comprising:
a vector element input field effect transistor having a first drain-source terminal, a gate, and a second drain source terminal; and
a weight field effect transistor having a first drain-source terminal coupled to the second drain-source terminal of the vector element input field-effect transistor, a gate, and a second drain source terminal;
wherein:
the gate of the vector element input field effect transistor is coupled to a corresponding one of the plurality of second input voltage lines;
the gate of the weight field effect transistor is coupled to a corresponding one of the plurality of first input voltage lines; and
the first source-drain terminal of the vector element input field effect transistor is coupled to a corresponding one of the summation lines.

3. The apparatus of claim 2, further comprising:
a first voltage rail;
a second voltage rail; and
a plurality of control voltage lines arranged in rows;
wherein:
the plurality of summation lines, the plurality of first input voltage lines, and the plurality of control voltage lines are arranged in the rows; and
the plurality of second input voltage lines are arranged in columns; and
the rows and columns intersect at a plurality of cell locations where the plurality of plurality of current-mode cells are located;
further comprising:
a plurality of first voltage supply lines arranged in the columns and coupled to the first voltage rail;
a plurality of second voltage supply lines arranged in the columns and coupled to the second voltage rail;
wherein:
each of the current mode cells further comprises a switch network coupled to the weight field effect transistor and coupled to a corresponding one of the plurality of first input voltage lines; and
the second drain-source terminal of the weight field effect transistor is coupled to one of the first and second voltage rails.

4. The apparatus of claim 3, wherein:
the weight field effect transistor is a lower transistor relative to the vector element input field effect transistor; and
the second drain-source terminal of the weight field effect transistor is coupled to the second voltage rail.

5. The apparatus of claim 4, wherein the weight field effect transistor and the vector element input field effect transistor comprise n-type field effect transistors.

6. The apparatus of claim 4, wherein the switch network is configured to:
render the weight field effect transistor ON, as an active current mirror, in a non-self-biased first mode;
render the weight field effect transistor OFF in a non-self-biased second mode; and
render the weight field effect transistor ON, in a self-biased third mode.

7. The apparatus of claim 6, further comprising:
a plurality of reference current sources configured to provide the plurality of corresponding reference currents.

8. The apparatus of claim 3, wherein:
the weight field effect transistor is an upper transistor relative to the vector element input field effect transistor; and
the first drain-source terminal of the weight field effect transistor is coupled to the first voltage rail.

9. The apparatus of claim 8, wherein the weight field effect transistor and the vector element input field effect transistor comprise n-type field effect transistors.

10. The apparatus of claim 8, wherein the switch network is configured to:
render the weight field effect transistor ON, as an active current mirror, in a non-self-biased first mode;
render the weight field effect transistor OFF in a non-self-biased second mode; and
render the weight field effect transistor ON, in a self-biased third mode.

11. The apparatus of claim 10, further comprising:
a plurality of reference current sources configured to provide the plurality of corresponding reference currents.

12. The apparatus of claim 3, further comprising:
a voltage supply; and
a controller configured to cause:
the voltage supply to supply a supply voltage to at least one of the first or second voltage rails;
signals associated with a weight vector to be applied to the plurality of first input voltage lines arranged in the rows; and
input signal values to be applied to the plurality of second input voltage lines arranged in the columns.

13. The apparatus of claim 2, wherein:
the plurality of summation lines, the plurality of first input voltage lines, the plurality of second input voltage lines, and the plurality of current-mode cells, comprise a first current mode multiply-accumulate core, further comprising a second current mode multiply-accumulate core coupled to the first current mode multiply-accumulate core.

14. An apparatus comprising:
a first current mode multiply-accumulate core configured to multiply each of a plurality of elements of a first input vector with first corresponding weights and to sum resulting products of the multiplication; and
a second current mode multiply-accumulate core configured to multiply each of a plurality of elements of a second input vector with second corresponding weights and to sum resulting products of the multiplication, the second current mode multiply-accumulate core being coupled to a first current mode multiply-accumulate core.

15. The apparatus of claim 14, further comprising a summation element, wherein a weighted output of the first current mode multiply-accumulate core and a weighted output of the second current mode multiply-accumulate core are input to the summation element, the summation element being configured to sum the weighted outputs of the first and second current mode multiply-accumulate cores.

16. The apparatus of claim 14, wherein an output of the first current mode multiply-accumulate core is supplied to an input of the second current mode multiply-accumulate core, and the second current mode multiply-accumulate core is configured to output a hierarchical product.

17. The apparatus of claim 14, further comprising a comparator, wherein a weighted output of the first current mode multiply-accumulate core and a weighted output of the second current mode multiply-accumulate core are input to the comparator, the comparator being configured to compare the weighted outputs of the first and second current mode multiply-accumulate cores and output a corresponding logical value.

18. An apparatus comprising:
a plurality of current mode multiply cells arranged in rows and columns;
a plurality of input mixers, each input mixer having an output coupled to an input of a corresponding row of current mode multiply cells, each input mixer having a signal input and a phase component input; and
a plurality of output mixers, each output mixer having a signal input coupled to an output of a corresponding row of current mode multiply cells and having a phase component input and an output.

18. The apparatus of claim 18, further comprising a plurality of receive antennas coupled to the signal inputs of the plurality of input mixers and a plurality of transmit antennas coupled to the signal outputs of the plurality of output mixers.

20. An apparatus comprising:
a first field effect transistor having a first source-drain terminal coupled to a first voltage rail, a gate, and a second source-drain terminal;
a second field effect transistor having a first source-drain terminal coupled to the second source-drain terminal of the first field effect transistor, a gate, and a second source-drain terminal;
a third field effect transistor having a first source-drain terminal coupled to the second source-drain terminal of the second field effect transistor, a gate, and a second source-drain terminal;
a fourth field effect transistor having a first source-drain terminal coupled to the second source-drain terminal of the third field effect transistor, a gate, and a second source-drain terminal coupled to a second voltage rail;
a fifth field effect transistor having a first source-drain terminal coupled to the second source-drain terminal of the first field effect transistor and the first source-drain terminal of the second field effect transistor, a gate, and a second source-drain terminal;
a sixth field effect transistor having a first source-drain terminal coupled to the second source-drain terminal of the fifth field effect transistor, a gate, and a second source-drain terminal coupled to the second source-drain terminal of the third field effect transistor and the first source-drain terminal of the fourth field effect transistor;
a first current mode multiply-accumulate core configured to multiply each of a plurality of elements of a first input vector with first corresponding weights and to sum resulting products of the multiplication, the first current mode multiply-accumulate core being coupled to the first source-drain terminal of the third field effect transistor and the second source-drain terminal of the second field effect transistor; and
a second current mode multiply-accumulate core configured to multiply each of a plurality of elements of a second input vector with second corresponding weights and to sum resulting products of the multiplication, the second current mode multiply-accumulate core being coupled to the first source-drain terminal of the sixth field effect transistor and the second source-drain terminal of the fifth field effect transistor.

21. The apparatus of claim 20, wherein the third and fifth field effect transistors comprise variable strength transistors.

22. The apparatus of claim 20, further comprising:
a seventh field effect transistor having a first source-drain terminal coupled to the second source-drain terminal of the first field effect transistor and the first source-drain terminal of the second field-effect transistor, a gate, and a second source-drain terminal coupled to the second voltage rail;
an eighth field effect transistor having a first source-drain terminal coupled to the second source-drain terminal of the second field effect transistor and the first source-drain terminal of the third field-effect transistor, a gate, and a second source-drain terminal coupled to the second voltage rail;
a ninth field effect transistor having a first source-drain terminal coupled to the first voltage rail, a gate, and a second source-drain terminal coupled to the second source-drain terminal of the fifth field effect transistor and the first source-drain terminal of the sixth field effect transistor; and
a tenth field effect transistor having a first source-drain terminal coupled to the first voltage rail, a gate, and a second source-drain terminal coupled to the second source-drain terminal of the sixth field effect transistor, the second source-drain terminal of the third field effect transistor, and the first source-drain terminal of the fourth field effect transistor.
